(19) United States
(12) Patent Application Publication
(10) Pub. No.: US 2026/0353496 A1
(43) Pub. Date: Nov. 5, 2026

(54) TECHNIQUES FOR OPTIMIZING USER EQUIPMENT CONNECTIONS ON SECONDARY NETWORKS

(71) Applicant: T-Mobile USA, Inc., Bellevue, WA (US)

(72) Inventor: Mehul Shah, Sammamish, WA (US)

(21) Appl. No.: 19/195,661

(22) Filed: Apr. 30, 2025

(51) Int. Cl. H04W 76/19; H04W 8/00; H04W 76/28

(52) U.S. Cl. CPC H04W 76/19; H04W 8/005; H04W 76/28

(57) ABSTRACT

Techniques are described herein for optimizing user equipment connections with a secondary network. Such techniques may comprise determining that a first connection to a primary network has been severed and identifying a secondary network available for establishing a second connection with the user equipment. The techniques may further comprise identifying policy data associated with the secondary network, determining, based on the policy data, a connection cadence associated with the secondary network, and establishing the second connection with the secondary network in accordance with the connection cadence.

### BACKGROUND

In telecommunication, wireless communication services may be provided to user equipment devices over a combination of different networks, either terrestrial or satellite. A terrestrial network, such as a Public Land Mobile Network (PLMN), may be enabled by a one or more terrestrial base stations positioned throughout a geographic region. In contrast, a satellite network may be enabled by a number (e.g., thousands) of small satellites stationed in orbit around the Earth. For example, a satellite network may be a Low Earth Orbit (LEO) network that includes a number of small satellites in low Earth orbit (e.g., 500 km in altitude) that are constantly moving relative to the Earth.

Due to recent advancements in wireless communication technology, many terrestrial networks are able to process large amounts of data without constraint. Many user equipment devices have been configured to operate on such unconstrained networks. However, user equipment devices that have been configured to operate on unconstrained networks may be too inefficient to operate effectively on constrained networks.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 depicts a diagram illustrating an example network architecture in which user equipment may be configured to operate effectively on both constrained and unconstrained networks in accordance with some embodiments.

FIG. 2 depicts a component diagram of an example system to be implemented in a network in order to enable implementation of dynamic adaptation by user equipment to network constraints in accordance with some embodiments.

FIG. 3 depicts a first exemplary connection cadence that is illustrated across a number of depicted timelines in accordance with embodiments.

FIG. 4 depicts a second exemplary connection cadence that is illustrated across a number of depicted timelines in accordance with embodiments.

FIG. 5 depicts a flow diagram illustrating an exemplary process for providing intelligent connection management that may be implemented by user equipment in accordance with at least some embodiments.

FIG. 6 shows an example computer architecture for a computing device capable of executing program components for implementing the functionality described above.

### DETAILED DESCRIPTION

This disclosure describes techniques and systems for optimizing user equipment connections with a secondary network. A user equipment device may initially be configured to operate on a primary network but may be capable of connecting to other (e.g., secondary) networks when the primary network is not available. In the case that the secondary networks have the same capabilities/resource requirements as the primary network, the user equipment device can smoothly transition between networks. However, some networks (and especially satellite networks) may have less available computing resources/bandwidth than the primary network and while the user equipment device may be capable of connecting to those networks, its existing configuration can result in a suboptimal connection.

Embodiments of the disclosure provide for a number of advantages over conventional systems. For example, the implemented system allows for improvements to managing resource constraints when switching between networks. Notably, some user equipment may be configured to operate on unconstrained networks that have unlimited bandwidth/computing resources. However, when those user equipment connect to networks that have more constraints, such a configuration may be at odds with the capabilities of those networks. The disclosed system allows for a user equipment to dynamically adjust its connection cadence to more closely align with the capabilities of a network to which it is connecting, allowing for a more optimal connection.

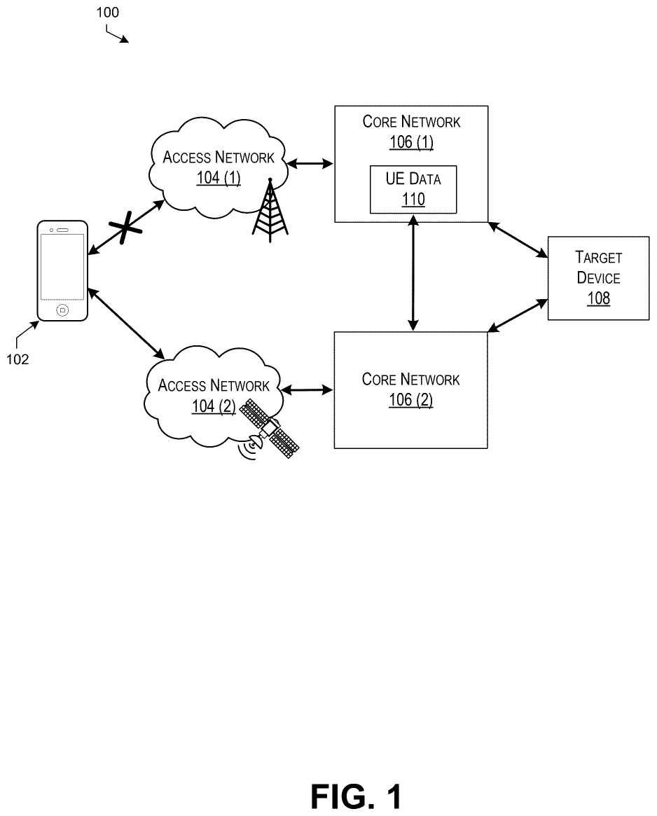

FIG. 1 depicts a diagram illustrating an example network architecture 100 in which user equipment may be configured to operate effectively on both constrained and unconstrained networks in accordance with some embodiments. The architecture 100 may include a user equipment (UE) 102 capable of connecting to one or more access networks 104 in order to communicate with a respective core network 106 in order to communicate with a target device 108.

In embodiments, a user equipment 102 connecting to the system may be capable of doing so using access networks that operate with different access technologies. For example, the user equipment 102 may be capable of connecting to both an access network 104(1) and an access network 104(2), where both of the access networks 104(1) and 104(2) can provide ingress/egress to a respective communication system but operate using different technology standards. For example, access network 104(1) may be a terrestrial network that operates using a 5G technology standard, whereas access network 104(2) may be a satellite network that operates using a different technology standard.

The access networks 104(1) and 104(2) may be compatible with one or more radio access technologies, protocols, and/or standards, such as 5G NR technology, LTE/LTE Advanced technology, other Fourth Generation (4G) technology, High-Speed Data Packet Access (HSDPA)/Evolved High-Speed Packet Access (HSPA+) technology, Universal Mobile Telecommunication System (UMTS) technology, WiMAX technology, Wi-Fi technology, and/or any other previous or future generation of radio access technology. Likewise, the access network may use any suitable cellular communications protocols, including a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a New Radio (NR) protocol, 5G New Radio (NR) technology used in Non-Terrestrial Networks (NTNs) (NR-NTN), and the like.

The access networks 104(1) and 104(2) may include various types of wireless access nodes. Such wireless access nodes may include both access nodes that provide access to unconstrained networks (such as terrestrial wireless networks) or to constrained networks (such as satellite wireless networks).

In an example implementation, wireless access nodes for a first access network 104(1) may include 2G base stations and/or 3G NodeBs that are associated with GSM and CDMA access networks, e-node Bs (eNBs) that are associated with an LTE access network also known as an Evolved UMTS Terrestrial Radio Access Network (E-UTRAN), or gNBs or new radio (NR) base stations that are associated with a 5G access network.

In this example implementation, wireless access nodes for a second access network 104(2) may include one or more Low Earth Orbit (LEO) satellites operating in a constellation. LEO constellations are satellite networks that consist of thousands of small satellites in low Earth orbit (e.g., 500 km in altitude). LEO satellites are constantly moving relative to the Earth, and thus constantly moving relative to routers and satellite dishes on Earth. The satellites in these LEO satellite networks are arranged in a shell (e.g., a grid or constellation) that move in unison according to predefined patterns or orbital paths. Each shell may include thousands, or tens of thousands, of LEO satellites. In essence, a given satellite network consists of several such shells, each of which includes many orbital planes. Given that satellites in different shells have distinct altitudes, they will have to maintain different speeds (often in excess of 25,000 km/h). In addition, satellites on different orbital planes will traverse the sky in paths that cross each other at different angles.

In embodiments, each of the access networks 104 (1 and 2) may be associated with a respective core network 106 (1 and 2). The core networks 106 may each be operated by a different cellular operator (e.g., carrier) that provide service to respective user equipment operating on their networks. In such cases, the different cellular operators may have an agreement to provide services to user equipment associated with the other cellular operator when that user equipment is unable to access their respective network. In some cases, a core network 106(2) may have access to user equipment (UE) data 110 maintained by the other core network 106(1), which can be used to manage services provided to the user equipment 102.

In embodiments, the user equipment Data 110 may be maintained by a Home Subscriber Server (HSS). A HSS is typically a master user database that supports the core network nodes that handle the calls/sessions. It contains user profiles, performs authentication and authorization of the user, and can provide information about the physical location of a user. A user profile may be associated with each user equipment 102 and may contain information about the current user. The HSS includes a database of subscriber information and user authentication details, as well as information for use in configuring calls and IP sessions. Multiple HSS nodes can optionally be synchronized to ensure proper cooperation and consistent function.

In embodiments, a target device 108 may be any suitable computing device with which a user equipment 102 is attempting to communicate. In some cases, the target device 108 may be a different user equipment device. For example, where the user equipment 102 is a cellular phone, the target device 108 may be another cellular phone that the user equipment 102 is attempting to call or text. In some embodiments, the target device 108 is a remote computing device that provides a service or software application support. For example, the target device 108 may be a remote server that provides backend support for a software application that is executed on the user equipment 102.

In operation, a user equipment 102 interacting with the architecture 100 may initially access the cellular network via access network 104(1) using 5G technology standards. Through this interaction, the user equipment 102 may be registered with a core network 106(1), such as an IMS network.

During operation, the user equipment 102 may become disconnected from the access network 104(1). In such a scenario, the user equipment 102 may attempt to reestablish its connection with the cellular network by identifying and connecting to an alternative access network. In some cases, the user equipment 102 may perform a discovery process to discover network connections that are currently available to the user device. In some cases, the user equipment 102 may further identify a type or category associated with the identified network connections. Upon identifying one or more access networks that are currently available, the user equipment may identify one or more connection policies to be implemented with respect to each of the identified access networks. Connection policies may be identified based on the type or category associated with the identified network connection. In some cases, implementing a connection policy associated with an identified network may cause the user equipment to create a continuous connection with the identified network connection. In other cases, implementing a connection policy associated with an identified network may cause the user equipment to communicate with the identified network connection only when such a communication is warranted.

The network architecture 100 as illustrated in FIG. 1 may be part of a telecommunication network of a wireless service provider such as, T-Mobile, AT&T, Verizon Wireless, etc. The telecommunication network may include one or more core networks 106 and one or more access networks including the access networks 104(1) and 104(2) and through which a user equipment 102 can connect to the one or more packet data networks (PDNs).

It should be understood that the network scenario shown in FIG. 1 is for the purpose of illustration. In various real-world scenarios, telecommunication networks or one or more subsystems of a telecommunication network can be logically divided into a number of regions. Each of the regions may logically include a packet core network and an IMS network.

The techniques discussed herein may be implemented in the telecommunication network using one or more protocols including but are not limited to Ethernet, 3G, 4G, 4G LTE, 5G, or any combination thereof. The techniques may also optionally be implemented in the telecommunication network using 6G and/or future radio access technologies.

For clarity, a certain number of components are shown in FIG. 1. It is understood, however, that embodiments of the disclosure may include more than one of each component. In addition, some embodiments of the disclosure may include fewer than or greater than all of the components shown in FIG. 1. In addition, the components in FIG. 1 may communicate via any suitable communication medium (including the Internet), using any suitable communication protocol.

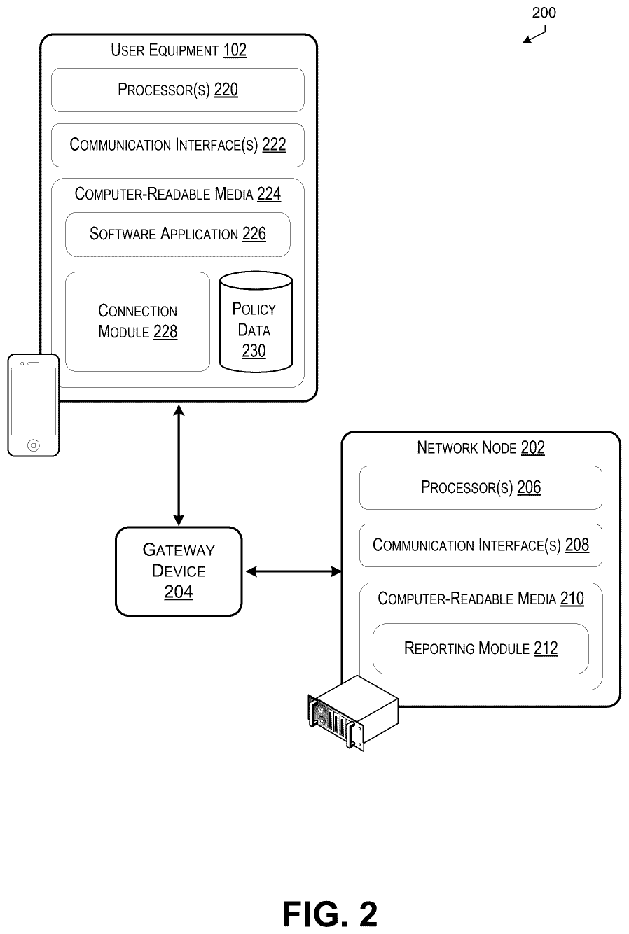

FIG. 2 depicts a component diagram of an example system to be implemented in a network in order to enable implementation of dynamic adaptation by user equipment to network constraints in accordance with some embodiments. As depicted in FIG. 2, a network node 202 may be in wireless communication with a user equipment 102 that is operated by a user. The connection between the user equipment 102 and the network node operating on a network may be made over a gateway device 204 operating in accordance with an access network (e.g., access network 104 of FIG. 1).

An exemplary network node 202 may be a computing device that is operating within a network (e.g., a cellular network). As depicted, the network node 202 may be implemented in communication with a gateway device 204. It should be noted that such a network node 202 (or any other described computing component) may be implemented as a single computing device (e.g., a server device) or a combination of computing devices. In some cases, the network node 202 may be implemented as a virtual device/system (e.g., via virtual machines implemented within a cloud computing environment).

As illustrated, the network node 202 may include one or more hardware processors 206 configured to execute one or more stored instructions. Such processor(s) 206 may comprise one or more processing cores. Further, the network node 202 may include one or more communication interfaces 208 configured to provide communications between the network node 202 and other devices, such as the user equipment 102 or any other suitable electronic device.

The network node 202 may also include computer-readable media 210 that stores various executable components (e.g., software-based components, firmware-based components, etc.). The computer-readable media 210 may store components to implement functionality described herein. While not illustrated, the computer-readable media 210 may store one or more operating systems utilized to control the operation of the one or more devices that comprise the network node 202. According to one instance, the operating system comprises the LINUX operating system. According to another instance, the operating system(s) comprise the WINDOWS® SERVER operating system from MICROSOFT Corporation of Redmond, Washington. According to further embodiments, the operating system(s) can comprise the UNIX operating system or one of its variants. It should be appreciated that other operating systems can also be utilized.

The computer-readable media 210 may include portions, or components, that configure the network node 202 to perform various operations described herein. For example, the computer-readable media 210 may include some combination of components configured to implement the described techniques. Particularly, the network node 202 may include a component configured to communicate with nodes in one or more other networks to ensure user equipment operation (e.g., reporting module 212).

The reporting module 212 may be configured to, when executed by the processors 220, cause the network node 202 to identify one or more user equipment 102 that could potentially connect to its network. In some cases, the user equipment 102 may be an off-network device. In other words, the user equipment 102 may be a device that normally operates on a network that is different from the one on which the network node 202 is operating upon. In such cases, the reporting module 212 may identify the user equipment 102 upon receiving a notification (e.g., a “heartbeat” message) from that user equipment 102 and/or upon receiving a request to establish a connection between itself and the user equipment 102. In some cases, the user equipment 102 may be identified by the network node 202 based on receiving a notification from a second network node operating on a different network that the user equipment is moving toward (or is already within) a geographic region covered by a network on which the network node 202 is operating.

Upon identifying one or more user equipment 102 that could potentially connect to a network on which the network node 202 is operating, the reporting module 212 may aggregate information about a number of messages/communications directed toward that user equipment. For example, a network node associated with a first network may, upon identifying a user equipment 102 that operates on a second network, communicate with a second network node operating on the second network to retrieve information about the user equipment 102 (e.g., account information) as well as one or messages/communications awaiting retrieval by the user equipment 102. The reporting module 212 may then maintain information about those messages/communications.

In embodiments, a connection may be established between the user equipment 102 and the network node 202. Such a connection may be established by the user equipment 102. In some cases, such a connection may be established upon the user equipment 102 providing a heartbeat message to the network node 202. In some embodiments, such a connection may be established upon occurrence of a transmit event (e.g., on execution of an application) on the user equipment that causes it to connect to a network. Upon the connection between the user equipment 102 and the network node 202 being established, the reporting module 212 may provide the user equipment with information about messages/communications available to the user equipment 102. The user equipment 102 may then initiate a retrieval of those messages/communications via the network node 202.

The user equipment 102 may be an example of a user equipment 102 as described in relation to FIG. 1 above. As noted elsewhere, a user equipment 102 may include any suitable electronic device configured to interact with a network.

Similar to the network node 202, the user equipment 102 may include one or more hardware processors 220 configured to execute stored instructions. Such processor(s) 220 may comprise one or more processing cores. Further, the user equipment 102 may include one or more communication interfaces 222 configured to provide communications between the user equipment 102 and other devices, such as a network node 202 or another suitable electronic device.

Similar to the network node 202, the user equipment 102 may include computer-readable media 224 that stores various executable components (e.g., software-based components, firmware-based components, etc.). The computer-readable media 224 may store components to implement functionality described herein. It should be appreciated by those skilled in the art that computer-readable storage media may include any available media that provides for the non-transitory storage of data and that can be accessed by the user equipment 102. In some examples, the operations performed by devices as described herein may be supported by one or more devices similar to user equipment 102. Stated otherwise, some or all of the operations performed by a user equipment, and/or any components included therein, may be performed by one or more computing device operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

The computer-readable media 224 may include portions, or components, that configure the user equipment 102 to perform various operations described herein. For example, the computer-readable media 224 may include some combination of components configured to implement the described techniques. In embodiments, the computer-readable media 224 of the user equipment 102 may include one or more software application 226, each of which may perform some functionality that relies upon data services accessed over a network. The computer-readable media 224 may further include a component configured to manage disconnection/connection with various networks (e.g., connection module 228). In embodiments, at least a portion of the techniques described may be performed after detecting unavailability of a vital service. Additionally, the computer-readable media 224 may further maintain one or more databases, such as a database of connection policies related to various networks (e.g., policy data 230).

A software application 226 may be any suitable set of computer-executable instructions that causes the user equipment 102 to perform a function. In embodiments, the software application 226 may be supported by a remote server, which may be represented as the target device 108 as described in relation to FIG. 1 above. In other words, when executed, the software application may cause the user equipment 102 to communicate with a remote server to perform at least a portion of the functionality provided by that software application 226. The network traffic generated during such a communication may be transmitted to the gateway device 204 to be routed to its intended destination device.

A connection module 228 may be configured to, upon determining that one or more primary networks are unavailable, cause the user equipment 102 to connect to a detected secondary network based on policy data related to that secondary network. In such cases, the connection module 228 may be configured to perform a discovery process in order to identify one or more networks available to it. For each of those one or more networks, the connection module 228 may identify policy data from the policy data 230 that is relevant to the respective network. In some cases, policy data relevant to any particular network may be determined based on a type or category associated with that network. In some cases, specific policy data may be maintained that relates to a specific network.

In embodiments, the connection module 228 may establish a connection to a network node 202 over a gateway device 204 based on the identified policy data. In some cases, the policy data may cause the connection module 228 to establish a stable and continuous connection. In some cases, the policy data may cause the connection module 228 to only establish a connection to the network node 202 on a periodic basis (e.g., to transmit a heartbeat or other suitable status message). In some cases, the policy data may cause the connection module 228 to only establish a connection to the network node 202 upon execution of a software application on the user equipment that requires access to a remote computing device (e.g., server).

As noted above, in some embodiments, the connection module 228 may establish a connection to a network node (e.g., via gateway device 204) on a periodic basis. For example, the connection module 228 may establish a connection to the network node 202, transmit a heartbeat message, wait a predetermined amount of time (e.g., a wake interval), and then severe that connection. In such cases, the connection module 228 may receive, via that connection, an indication of one or more messages/communications that are awaiting delivery to the user equipment. In such cases, the connection may be maintained past a wake interval in order to retrieve each of the undelivered communications.

In some embodiments, the connection module 228 may be configured to establish a connection to a network node (e.g., via gateway device 204) upon execution of a software application on the user equipment that requires access to a remote computing device. In such cases, upon detecting the execution of the software application, the connection module 228 may cause the user equipment 102 to establish a connection with the network node 202 via a gateway device 204. In such cases, the connection module 228 may be configured to monitor network traffic conveyed over that connection. Upon detecting that such network traffic has ceased, the connection module 228 may be configured to wait for a predetermined amount of time (e.g., an active interval) before severing the connection. For example, the connection module 228 may be configured to wait 10 minutes within which no network traffic is detected before severing the connection.

In some cases, the user equipment 102 may receive updated policy data 230 from one or more network nodes operating on a network. In some cases, the policy data 230 is received periodically (e.g., every hour). In other cases, the policy data 230 is pushed to the user equipment 102 by one or more devices operating on the network as that policy data 230 is updated. In some cases, policy data 230 may be provided to a user equipment 102 upon a network node 202 making a prediction that the user equipment 102 is going to enter a zone or area in which that user equipment will not have access to a primary network. In some embodiments, policy data 230 may be retrieved by the user equipment 102 from a secondary network (e.g., via a second network node operating on a network different from the one on which network node 202 is operating) upon the user equipment 102 detecting that its connection to a primary network has been severed.

During operation, the user equipment may make a determination that a primary network has become unavailable. For example, the user equipment may determine that a connection to the primary network has been severed or the user equipment is in a geographic region that is not currently serviced/reachable via one or more base stations associated with the primary network. In that case, the user equipment 102 may perform a discovery process to identify secondary networks that are available to the user equipment. The user equipment 102 may then identify policy data associated with each of the relevant networks and subsequently implement the identified policy data to establish communication with a selected network.

In the above operation, the connection module 228 may establish a connection to a network node 202 over a gateway device 204 based on the identified policy data. As noted above, the policy data may cause the user equipment to establish a stable and continuous connection, to only establish a connection to the network on a periodic basis, or to only establish a connection to the network upon execution of a software application on the user equipment that requires access to a remote computing device.

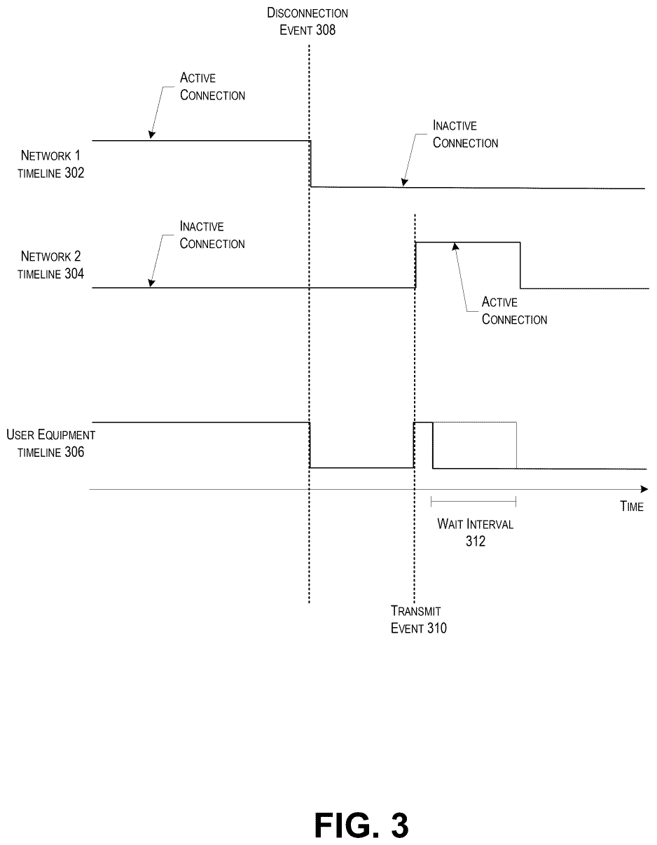

FIG. 3 depicts a first exemplary connection cadence that is illustrated across a number of depicted timelines in accordance with embodiments. Particularly, FIG. 3 depicts a first timeline 302 that represents activity over a connection between a user equipment and a first network (network 1), a second timeline 304 that represents activity over a connection between the user equipment and a second network (network 2), and a third timeline 306 that represents activity occurring on the user equipment.

As depicted via timeline 302 and timeline 306, the user equipment may maintain an active connection with Network 1 up until the occurrence of a disconnection event 308. In some cases, the disconnection event 308 may correspond to the Network 1 becoming unavailable for access by the user equipment. In one example, one or more base stations that provide access to Network 1 may malfunction. In another example, the user equipment may leave a geographic area that is serviced by the Network 1. After the occurrence of the disconnection event 308, the connection between the user equipment and Network 1 may remain inactive.

During that time, the user equipment may make a determination that Network 2 is available for connection. The user equipment may then identify stored policy data that relates to Network 2. In the scenario depicted in FIG. 3, the Network 2 may be a constrained network (e.g., operating with limited resources) and the identified policy data may dictate that an active connection should be established between the user equipment and network 2 only upon the occurrence of a transmit event 310. In embodiments, a transmit event 310 may be any event in which a request is executed on the user equipment to establish a network connection. For example, a transmit event 310 may represent any event that requires the transmission of network traffic between the user device and another device. Such a transmit event 310 may occur when a software application is executed on the user equipment that requires access to a remote computing device accessible over a network connection. Alternatively, a transmit event 310 may occur upon initiation of a voice call or sending of a message (e.g., a SMS message) to another device.

Upon detecting the transmit event 310, the user equipment may be configured to establish a connection between itself and Network 2. The user equipment may then convey any relevant network traffic over that connection to complete the transmit event. In some cases, once the transmit event 310 has ended, the connection between the user equipment and the Network 2 may be severed after a wait interval 312 has elapsed. In some cases, the active interval 312 may be restarted each time that new network traffic is transmitted over the active connection. In embodiments, an amount of time associated with the active interval 312 may be determined based on information included in the identified policy data.

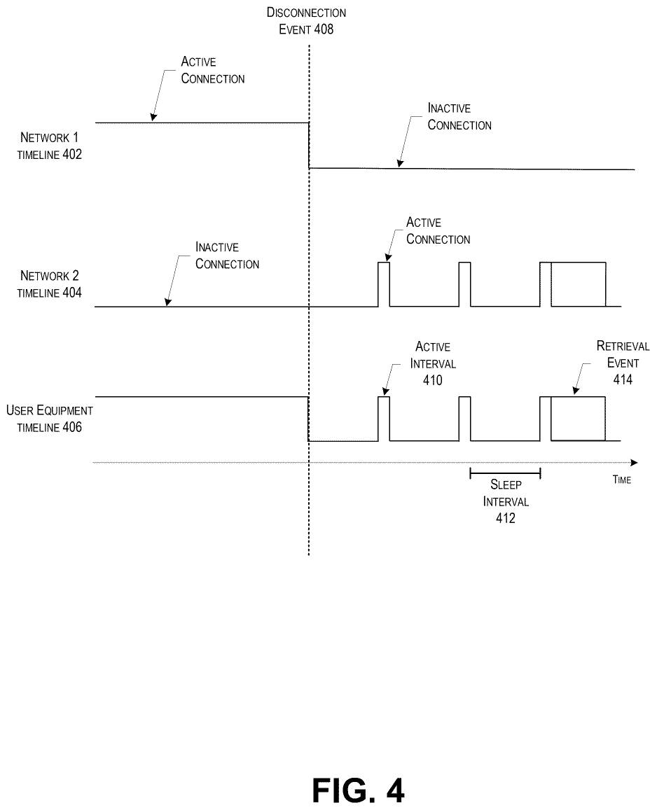

FIG. 4 depicts a second exemplary connection cadence that is illustrated across a number of depicted timelines in accordance with embodiments. Similar to above, FIG. 4 depicts a first timeline 402 that represents activity over a connection between a user equipment and a first network (Network 1), a second timeline 404 that represents activity over a connection between the user equipment and a second network (Network 2), and a third timeline 406 that represents activity occurring on the user equipment.

As depicted via timeline 402 and timeline 406, the user equipment may maintain an active connection with Network 1 up until the occurrence of a disconnection event 408. In some cases, the disconnection event 408 may correspond to the Network 1 becoming unavailable for access by the user equipment. In one example, one or more base station that provides access to Network 1 may malfunction. In another example, the user equipment may leave a geographic area that is serviced by the Network 1. After the occurrence of the disconnection event 408, the connection between the user equipment and Network 1 may remain inactive.

During that time, the user equipment may make a determination that Network 2 is available for connection. The user equipment may then identify stored policy data that relates to Network 2. In the scenario depicted in FIG. 4, the Network 2 may be a constrained network (e.g., operating with limited resources) and the identified policy data may dictate that an active connection should be established between the user equipment and Network 2 on a periodic basis. Notably, such a connection may be established at periodic intervals in order for the user equipment to transmit a status update message (e.g., a heartbeat message) to a node operating on the network.

In embodiments, the user equipment may establish an active connection with the Network 2 during a series of active intervals 410 and sever that connection during a sleep interval 412. Each two active intervals 410 in a series may be separated by a sleep interval 412. In these embodiments, each active interval 410 may last a predetermined amount of time. Likewise, each sleep interval may last a different amount of time. In some cases, the amount of time attributed to either or both of the active interval 410 and the sleep interval 412 may be determined based on information stored in policy data.

In some embodiments, an active interval 410 may be extended upon detecting a retrieval event 414. In such cases, the user equipment may receive a notification that one or more messages/communications are awaiting retrieval by the user equipment. The user equipment may retrieve at least a portion of those messages/communications and extend the active interval 410 until the retrieval has been completed. In some embodiments, the user equipment may retrieve only some, or none, of the messages awaiting retrieval. Notably, the user equipment may only retrieve messages associated with a threshold priority or associated with specified software applications and/or messaging services.

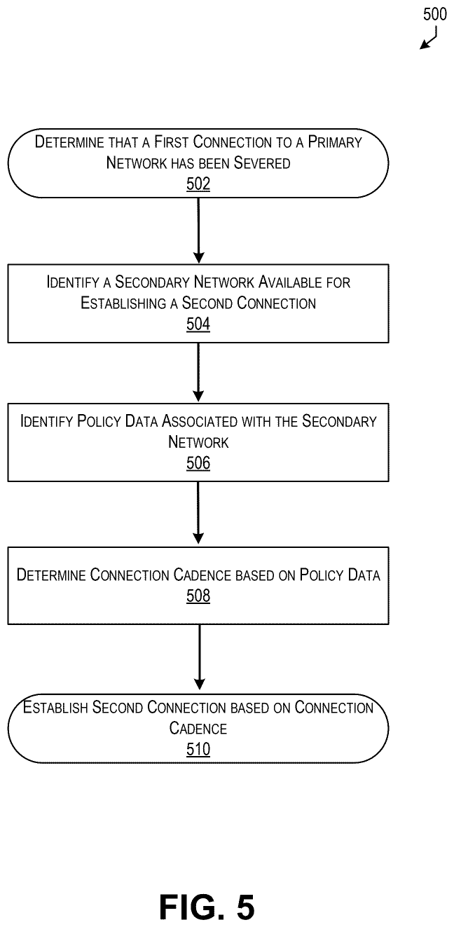

FIG. 5 depicts a flow diagram illustrating an exemplary process for providing intelligent connection management that may be implemented by user equipment in accordance with at least some embodiments. In embodiments, the process 500 as depicted in FIG. 5 may be performed by a user equipment in communication with a network. In some embodiments, a first network comprises a public land mobile network (PLMN) whereas a second network comprises a satellite network. In some cases, a first network is operated by a first carrier and a second network is operated by a second carrier that is different from the first carrier.

At 502, the process 500 may involve determining that a first connection to a primary network has been severed. In some embodiments, the first network maintains an account associated with the at least one user equipment. For example, the first network may be a carrier that provides cellular service to the user equipment.

At 504, the process 500 may involve identifying a secondary network available for establishing a second connection with the user equipment. In some cases, the first network may be configured to provide information associated with an account to the secondary network. For example, upon detecting the presence of the user equipment within a geographic region serviced by the secondary network, the secondary network may submit a request to the first network for information about that user equipment. In such cases, the first network may respond by providing at least a portion of the information associated with the account to the secondary network.

At 506, the process 500 may involve identifying policy data associated with the secondary network. In some embodiments, the policy data may be identified based on a type or category associated with the secondary network. In some embodiments, the policy data is provided to the user equipment by the primary network. For example, a network node operating on the primary network may provide the policy data to the user equipment upon predicting that the user equipment will be in range of the secondary network. In some embodiments, the policy data is provided to the user equipment by the secondary network in an initial communication. For example, upon performing a discovery process and detecting the availability of the secondary network, the user equipment may establish a short connection in order to notify the secondary network of its presence. In this example, the secondary network may provide the policy data to the user equipment during this short connection.

At 508, the process 500 may involve determining, based on the policy data, a connection cadence associated with the secondary network. In some embodiments, the connection cadence comprises a series of active intervals separated by sleep intervals. In such embodiments, a length of time associated with at least one of the active intervals or sleep intervals may be determined based on the policy data. In some embodiments, the connection cadence comprises one or more conditions under which the second connection should be established as well as a wait interval. In such cases, the process may further involve severing the second connection after the wait interval has elapsed. In embodiments, the connection cadence may be determined based at least in part on a level of resources available on the second network.

At 510, the process 500 may involve establishing the second connection with the secondary network in accordance with the connection cadence. In some cases, this may involve establishing a connection and severing it after a predetermined amount of time.

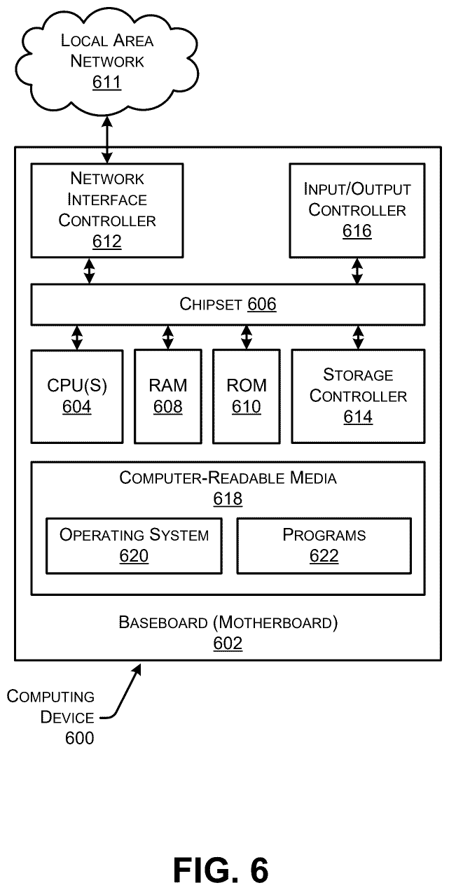

FIG. 6 shows an example computer architecture for a computing device 600 capable of executing program components for implementing the functionality described above. The computer architecture shown in FIG. 6 illustrates a conventional server computer, workstation, desktop computer, laptop, tablet, network appliance, e-reader, smartphone, or other computing device, and can be utilized to execute any of the software components presented herein. The computing device 600 may, in some examples, correspond to a physical server as described herein, and may comprise networked devices such as servers, switches, routers, hubs, bridges, gateways, modems, repeaters, access points, etc.

The computing device 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computing device 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computing device 600. The chipset 606 can further provide an interface to a computer-readable storage medium such as a read-only memory (“ROM”) 610 or non-volatile RAM (“NVRAM”) for storing basic routines that help to startup the computing device 600 and to transfer information between the various components and devices. The ROM 610 or NVRAM can also store other software components necessary for the operation of the computing device 600 in accordance with the configurations described herein.

The computing device 600 can operate in a networked environment using logical connections to remote computing devices and computer systems through a network, such as the network 611. The chipset 606 can include functionality for providing network connectivity through a NIC 612, such as a gigabit Ethernet adapter. The NIC 612 is capable of connecting the computing device 600 to other computing devices over the network 611. It should be appreciated that multiple NICs 612 can be present in the computing device 600, connecting the computer to other types of networks and remote computer systems.

The computing device 600 can be connected to a storage device 618 that provides non-volatile storage for the computer. The storage device 618 can store an operating system 620, programs 622, and data, which have been described in greater detail herein. The storage device 618 can be connected to the computing device 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing device 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computing device 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 600 can further read information from the storage device 618 by detecting the physical states or characteristics of one or more particular locations within the physical storage units.

In addition to the mass storage device 618 described above, the computing device 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computing device 600. In some examples, the operations performed by devices as described herein may be supported by one or more devices similar to computing device 600. Stated otherwise, some or all of the operations performed by an edge device, and/or any components included therein, may be performed by one or more computer device 600 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computing device 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computing device 600.

In one embodiment, the storage device 618 or other computer-readable storage media is encoded with computer-executable instructions which, when loaded into the computing device 600, transform the computer from a general-purpose computing system into a special-purpose computer capable of implementing the embodiments described herein. These computer-executable instructions transform the computing device 600 by specifying how the CPUs 604 transition between states, as described above. According to one embodiment, the computing device 600 has access to computer-readable storage media storing computer-executable instructions which, when executed by the computing device 600, perform the various processes described above with regard to the other figures. The computing device 600 can also include computer-readable storage media having instructions stored thereupon for performing any of the other computer-implemented operations described herein.

The computing device 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computing device 600 might not include all of the components shown in FIG. 6, can include other components that are not explicitly shown in FIG. 6, or might utilize an architecture completely different than that shown in FIG. 6.

As described herein, the computing device 600 may include one or more hardware processors (CPU 604) configured to execute one or more stored instructions. The processor(s) may comprise one or more cores. Further, the computing device 600 may include one or more network interfaces configured to provide communications between the computing device 600 and other devices, such as the communications described herein as being performed by an edge device. The network interfaces may include devices configured to couple to personal area networks (PANs), wired and wireless local area networks (LANs), wired and wireless wide area networks (WANs), and so forth. More specifically, the network interfaces include the mechanical, electrical, and signaling circuitry for communicating data over physical links coupled to the network 611. The network interfaces may be configured to transmit and/or receive data using a variety of different communication protocols. Notably, a physical network interface may also be used to implement one or more virtual network interfaces, such as for virtual private network (VPN) access, known to those skilled in the art. In one example, the network interfaces may include devices compatible with Ethernet, Wi-Fi™, and so forth.

The programs 622 may comprise any type of programs or processes to perform the techniques described in this disclosure. The programs 622 may comprise any type of program that cause the computing device 600 to perform techniques for communicating with other devices using any type of protocol or standard usable for determining connectivity. These software processors and/or services may comprise modules located within individual network interfaces.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In general, routing module contains computer executable instructions executed by the processor to perform functions provided by one or more routing protocols. These functions may, on capable devices, be configured to manage a routing/forwarding table (a data structure) containing, e.g., data used to make routing forwarding decisions. In various cases, connectivity may be discovered and known, prior to computing routes to any destination in the network, e.g., link state routing such as Open Shortest Path First (OSPF), or Intermediate-System-to-Intermediate-System (ISIS), or Optimized Link State Routing (OLSR). For instance, paths may be computed using a shortest path first (SPF) or constrained shortest path first (CSPF) approach. Conversely, neighbors may first be discovered (i.e., a priori knowledge of network topology is not known) and, in response to a needed route to a destination, send a route request into the network to determine which neighboring node may be used to reach the desired destination. Example protocols that take this approach include Ad-hoc On-demand Distance Vector (AODV), Dynamic Source Routing (DSR), DYnamic MANET On-demand Routing (DYMO), etc. Notably, on devices not capable or configured to store routing entries, routing module may implement a process that consists solely of providing mechanisms necessary for source routing techniques. That is, for source routing, other devices in the network can tell the less capable devices exactly where to send the packets, and the less capable devices simply forward the packets as directed.

In various embodiments, as detailed further below, various modules may also include computer executable instructions that, when executed by processor(s), cause computing device 700 to perform the techniques described herein. To do so, in some embodiments, various modules may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various embodiments, various modules may employ one or more supervised, unsupervised, or semi-supervised machine learning models. Generally, supervised learning entails the use of a training set of data, as noted above, that is used to train the model to apply labels to the input data. For example, the training data may include sample telemetry that has been labeled as normal or anomalous. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example machine learning techniques that path evaluation process can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of times the model incorrectly predicted an undesirable behavior of a path, such as its delay, packet loss, and/or jitter exceeding one or more thresholds. Conversely, the false negatives of the model may refer to the number of times the model incorrectly predicted acceptable path behavior. True negatives and positives may refer to the number of times the model correctly predicted whether the behavior of the path will be acceptable or unacceptable, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
determining, by a user equipment, that a first connection to a primary network has been severed;
identifying, by the user equipment, a secondary network available for establishing a second connection with the user equipment;
identifying, by the user equipment, policy data associated with the secondary network;
determining, by the user equipment based on the policy data, a connection cadence associated with the secondary network;
establishing, by the user equipment, the second connection with the secondary network in accordance with the connection cadence.

2. The method of claim 1, wherein the connection cadence comprises a series of active intervals separated by sleep intervals.

3. The method of claim 2, wherein a length of time associated with at least one of the active intervals or sleep intervals is determined based on the policy data.

4. The method of claim 1, wherein the connection cadence comprises one or more conditions under which the second connection should be established as well as a wait interval.

5. The method of claim 4, further comprising severing the second connection after the wait interval has elapsed.

6. The method of claim 1, wherein the policy data is identified based on a type or category associated with the secondary network.

7. The method of claim 1, wherein the policy data is provided to the user equipment by the primary network upon predicting that the user equipment will be in range of the secondary network.

8. The method of claim 1, wherein the policy data is provided to the user equipment by the secondary network in an initial communication.

9. A user equipment device comprising:
one or more processors; and
one or more non-transitory computer-readable media storing computer-executable instructions that, when executed by the one or more processors, cause the user equipment device to perform operations comprising:
determining that a first connection to a primary network has been severed;
identifying a secondary network available for establishing a second connection with the user equipment;
identifying policy data associated with the secondary network;
determining, based on the policy data, a connection cadence associated with the secondary network;
establishing the second connection with the secondary network in accordance with the connection cadence.

10. The user equipment device of claim 9, wherein the connection cadence comprises a series of active intervals separated by sleep intervals.

11. The user equipment device of claim 9, wherein the connection cadence comprises one or more conditions under which the second connection should be established as well as a wait interval.

12. The user equipment device of claim 9, wherein the policy data is identified based on a type or category associated with the secondary network.

13. The user equipment device of claim 9, wherein the policy data is provided to the user equipment by the primary network upon predicting that the user equipment will be in range of the secondary network.

14. The user equipment device of claim 9, wherein the policy data is provided to the user equipment by the secondary network in an initial communication.

15. The user equipment device of claim 9, wherein a length of at least one time interval of the connection cadence is determined based on the policy data.

16. A system comprising:
a first network comprising one or more network nodes; and
at least one user equipment, the at least one user equipment configured to:
receive policy data over a first connection to the first network;
determine that a first connection to the first network has been severed;
identifying a second network available for establishing a second connection with the user equipment;
determining, based on the policy data, a connection cadence associated with the second network;
establishing the second connection with the second network in accordance with the connection cadence.

17. The system of claim 16, wherein the policy data is received upon the one or more network nodes predicting that the at least one user equipment is likely to connect to the second network.

18. The system of claim 16, wherein the first network maintains an account associated with the at least one user equipment.

19. The system of claim 18, wherein the first network is configured to provide information associated with the account to the second network.

20. The system of claim 16, wherein the connection cadence is determined based at least in part on a level of resources available on the second network.
